(19) United States
(12) Patent Application Publication
(10) Pub. No.: US 2003/0020879 A1
(43) Pub. Date: Jan. 30, 2003

(54) Stereoscopic display and projection-type stereoscopic display

(75) Inventor: Tomio Sonehara, Shiojiri-shi (JP)

Correspondence Address: OLIFF & BERRIDGE, PLC, P.O. BOX 19928, ALEXANDRIA, VA, 22320, US

(73) Assignee: Seiko Epson Corporation, Tokyo (JP)

(21) Appl. No.: 10/201,773

(22) Filed: Jul. 25, 2002

(30) Foreign Application Priority Data
Jul. 26, 2001 (JP) 2001-226773
Oct. 4, 2001 (JP) 2001-309109

(51) Int. Cl. G03B 21/00

(52) U.S. Cl. 353/7

(57) ABSTRACT

The invention provides a stereoscopic display capable of achieving three-dimensional images with excellent display quality and without using polarized glasses or the like. A stereoscopic display according to the present invention includes a device to electronically form composite stereoscopic images, an image forming device to reproduce real images of the composite stereoscopic images, and a focal device to substantially align the real images with a focal point position of eyes of an observer. In order to further enhance display performance, there are provided a Z-direction scanning device, a rotationally scanning device, and a matrix-type display that forms the composite stereoscopic images. On the other hand, there is provided a composite stereoscopic image-forming device including a projection device and a scanning-type scattering screen. In order to enhance display contrast, there are provided a polarization element and a polarized light separating device. Furthermore, the number of openings of a final optical element is preferably larger to increase a visible range, so that a reflection optical element with a large opening is provided as the image-forming device.

### BACKGROUND OF THE INVENTION

1. Field of Invention

The present invention relates to real-image reproducing stereoscopic displays. More specifically, the invention relates to a stereoscopic display to permit observation of three-dimensional images without the help of polarized glasses or the like. The invention also relates to a projection-type stereoscopic display.

2. Description of Related Art

Stereoscopic display can be achieved by related art real image-reproducing stereoscopic displays that use a concave mirror or convex lens, which are disclosed in U.S. Pat. Nos. 2,628,533, 3,647,284, and 5,508,763.

The related art includes a device known as a binocular stereoscopic display. However, the binocular stereoscopic display achieves a stereoscopic effect employing a binocular parallax in physiological contributing factors, so that there have been problems that an observing device, such as polarized glasses, is required, and when using it for a long time, an observer feels tired. In order to practically display stereoscopic images, a depth sampling technique can be used, in which a three-dimensional object is sampled in the depth direction to have aggregation of a number of two-dimensional images, which in turn are rearranged in the depth direction to display three-dimensional images.

### SUMMARY OF THE INVENTION

However, since the stereoscopic displays employing related art real-image reproducing systems entail projection of a real object, so that the real object to be projected is required. Also, if a CRT is used, it can only float planar images, i.e., two-dimensional images, in a space.

On the other hand, depth-sampling methods disclosed in Japanese Unexamined Patent Application Publication Nos. 11-218844 and 9-243960 comparatively simply reproduce stereoscopic images and are excellent at this point. However, in related art methods, due to the existence of a screen in a stereoscopic display space and of a lens in the front, an observer cannot enter the display space. Therefore, the conjunction with an inner force sense is difficult, so that there has been a problem that the position of an observer is limited.

The present invention addresses the above-mentioned problems, and provides a stereoscopic display capable of achieving three-dimensional images that are excellent in display quality without the help of polarized glasses or the like.

In order to address the above problems, a stereoscopic display according to a first invention includes a device to electronically form composite stereoscopic images, an image forming device to reproduce real images of the composite stereoscopic images, and a focal device to substantially align the real images with a focal point position of eyes of an observer.

The stereoscopic display according to the present invention is a real-image reproducing stereoscopic display, in which composite stereoscopic images are electronically formed by a so-called depth sampling system, and further real images of the composite stereoscopic images are formed by an image-forming system on a space to be observed. Although, it is difficult for observer's eyes to adjust the focus on a space without anything, forming the focal device facilitates observation. Therefore, according to this configuration, stereoscopic images can be simultaneously observed by a number of people without the help of polarized glasses or the like. Because the real images are viewed in principle, tiredness due to the difference between the vergence and focal point is not produced. Also, because the stereoscopic images are electronically formed, they are also applicable to moving images.

Preferably, in the image forming device, a final optical component to form the real images is a reflection optical element.

In order to increase the visible range, it is preferable that the number of openings of the final optical element be large, so that by adopting a reflection type as the final optical component as in the present invention, a wide visible range can be achieved with reasonable cost. Since bending of optical paths is required in a reflection system, there is also an advantage of reduction in size of the entire apparatus.

Preferably, the image forming device of the stereoscopic display according to the first invention is an optical system including a polarization element to polarize light functioning to form the real images and a polarization element to select display light.

The light entering the image-forming system includes not only the light to form stereoscopic images, but also outside light and multiple-reflected light. Then, the light emitted from the composite stereoscopic images is polarized so as to select or detect it at any place of the optical system of the image-forming system, so that the noise light can be reduced. Also, because at least half of the outside light from the observer side can be absorbed, real images with high contrast can be observed.

Preferably, a display according to the first invention further includes a final optical component of the image forming device including a large aperture concave mirror, a polarization element including a polarization splitting mirror to select the display light, and a polarization rotating element to rotate the polarized light when reflecting at the large aperture concave mirror.

As a further progressive reflection optical image-forming system, the visible range is increased by the large-aperture concave mirror and by using the polarization splitting mirror, the incident light from the composite stereoscopic images and the emitting light heading to form the real images are separated from each other utilizing polarization. At this time, the rotation at the reflection mirror is performed by using the phase plate or the like. By such a configuration, in addition to the black background due to the absorption by the dark box, the real images with high contrast can be achieved.

A stereoscopic display to observe real images according to a second aspect of the invention includes a device to electronically form composite stereoscopic images, and an image forming device to reproduce the real images of the composite stereoscopic images, where the composite stereoscopic images are formed by scanning two-dimensional images produced by a two-dimensional image forming device at a high speed in a depth direction. That is, the two-dimensional images electronically formed by the depth sampling system are scanned at a high speed in the depth direction, so as to form the composite stereoscopic images. The depth information data can be thereby displayed consistently, enabling the real images with stereoscopic feeling to be observed. Also, the composition with an inner force sense can be easily performed.

Preferably, furthermore, the two-dimensional image forming device displays two-dimensional images in which the image magnification and the aberration of the image forming device are corrected corresponding to the two-dimensional images and a scanning position in the depth direction. This enables the two-dimensional images to be displayed to be changed corresponding to a scanning position by referring a table included in the image forming system to correct distortion in advance. This method has a high degree of freedom and is simple more than the optical correction.

A stereoscopic display to observe real images according to a third aspect of the invention includes a device to electronically form composite stereoscopic images and an image forming device to reproduce the real images of the composite stereoscopic images. The composite stereoscopic images are formed by rotationally scanning two-dimensional images produced by a two-dimensional image forming device about a rotational axis parallel to an image surface.

Thereby, a depth information sampling device is enabled not only to scan in the Z-direction but also to rotationally scan, so that scanning with small mechanical vibration can be performed in comparison to linear scanning.

Preferably, furthermore, a two-dimensional image forming device to form the composite stereoscopic images according to the third invention is a matrix-type light emitting display.

According to the present invention, in order to form composite stereoscopic images, it is at least required to have widespread luminous flux corresponding to the opening in the image-forming system. In this respect, the light-emitting matrix-type display with a wide light-emitting pattern is preferable. Furthermore, the light-emitting matrix-type display, such as an LED and an OLED, can display very fine two-dimensional images or full-color two-dimensional images at a high speed, so that composite stereoscopic images with high-quality can be formed.

Preferably, the two-dimensional image forming device to form the composite stereoscopic images according to the third invention is a scattering-type liquid crystal display.

According to the present invention, in order to form composite stereoscopic images, it is at least required to have widespread luminous flux corresponding to the opening in the image-forming system. In this respect, the scattering-type matrix-type display is preferable. Furthermore, an active matrix-type display, such as a PDLC liquid crystal mode, can display very fine two-dimensional images at a high speed, so that composite stereoscopic images with high-quality can be formed.

Moreover, a light source can be modulated independently from two-dimensional images, so that a full-color display by a color sequential system is possible.

A stereoscopic display to observe real images according to a fourth aspect of the invention includes a device to electronically form composite stereoscopic images, and an image forming device to reproduce the real images of the composite stereoscopic images. The composite stereoscopic images are formed by synchronously projecting two-dimensional images produced by a two-dimensional image forming device on a scattering-type screen scanned at a high speed.

This is to obtain composite stereoscopic images by projection, that is, as the projecting method; two-dimensional images are projected at a high speed on the scanned scattering-type screen. By this technique, the forming space of the composite stereoscopic image and the projector, which is two-dimensional image-forming device, can be mechanically separated from each other, enabling the display panel to be installed at a place without mechanical movement. Thereby, reduction in reliability due to the mounting of the display panel on a movable part can be avoided.

Furthermore, preferably, in the scattering-type screen of the fourth aspect of the invention, deposited scattering-type liquid crystal being switchable between a scattered state and a transparent state of light is sequentially and electrically scanned.

Thereby, the reliable depth scanning can be performed at a high speed completely without a mechanical moving part, enabling stable composite stereoscopic images to be obtained.

Preferably, the composite stereoscopic images formed by synchronous projection on the scattering-type screen of the fourth aspect of the invention are synchronously projected by a projection device including a controller to control the relative distance between a projection lens and the scattering-type screen.

Thereby, the size of the two-dimensional images varying with the projection distance of the projector can be optically corrected.

Preferably, the composite stereoscopic images formed by synchronous projection on the scattering-type screen of the fourth aspect of the invention are synchronously projected by using a telecentric-type magnification optical system.

Thereby, the size of the two-dimensional images varying with the projection distance of the projector can be substantially kept constant.

Preferably, in the fourth aspect of the invention, the number of depth-information samplings of the composite stereoscopic images is set to be larger than the number of samplings of two-dimensional images capable of being displayed.

That is, in a depth sampling technique, the depth information of a three-dimensional object to be displayed is sampled and rearranged in time-series; because of the limitation of scanning, the number of the two-dimensional images corresponding to the scanning is also limited. Then, the depth information obtained by over sampling is time-shared and superimposed using interpolation of human eyes, so that more continuous and perspective three-dimensional images can be viewed.

A stereoscopic display to observe real images according to a fifth aspect of the invention includes a device to electronically form composite stereoscopic images, and a reflection image forming device to reproduce the real images of the composite stereoscopic images. The reflection image forming device is an optical system including a reflection polarized-light selection element to reflect and separate the polarized light functioning to form the real images between the composite stereoscopic images and the formed real images and a phase plate to rotate the polarized light functioning to form the real images.

Thereby, only the display polarized-light responsible for image-formation from the composite-stereoscopic images is reflected and rotated in polarization so as to separate noise light passing through an unwilled optical path by the reflection polarized-light selection element to enhance display contrast. Also, because the polarized-light from the composite-stereoscopic images is blocked, only the formed real images can be observed.

Preferably, the reflection polarized-light selection element of the fifth aspect of the invention corresponds to linearly polarized light perpendicular to the incident light in the substantially vertical direction and has a function to select between reflection and transmission.

The light path necessary for image formation can be thereby reduced in size so as to control the volume of the apparatus.

Preferably, the reflection image forming device of the fifth invention includes an optical system including the reflection polarized-light selection element to separate display light and noise light from the polarized light functioning to form the real images and a polarization element to transmit the display light.

Thereby, the noise light due to the reflection of outside light included in the reflection polarized-light selection element and the noise light transmitted from the inside of the image-forming system can be absorbed. Furthermore, the intrusion of outside light into the image-forming device is further reduced or, enabling the real images with high contrast to be observed.

As described above, according to the stereoscopic display of the present invention, moving stereoscopic image with high quality can be reproduced in a space. That is, since human both eyes parallax is not utilized, polarized glasses or the like are not required, so that a stereoscopic display capable of displaying natural three-dimensional stereoscopic images can be achieved.

### BRIEF DESCRIPTION OF THE DRAWING

FIG. 1 is a schematic of a stereoscopic display according to a first embodiment of the present invention;

FIG. 2 is a perspective view showing a stereoscopic image-forming device in the stereoscopic display according to the first embodiment;

FIG. 3 is a schematic of a stereoscopic display according to a second embodiment of the present invention;

FIG. 4 is a perspective view showing another forming method of electronic composite stereoscopic images;

FIG. 5 is a schematic of a stereoscopic display according to a third embodiment of the present invention;

FIG. 6 is a schematic of a stereoscopic display according to a fourth embodiment of the present invention;

FIG. 7 is a schematic showing another projection-type stereoscopic display in the stereoscopic display according to the fourth embodiment;

FIG. 8 is a schematic of a stereoscopic display according to a fifth embodiment of the present invention;

FIG. 9 is a schematic showing another stereoscopic display in the stereoscopic display according to the fifth embodiment;

FIG. 10 is a schematic showing another stereoscopic display in the stereoscopic display according to the fifth embodiment.

### DETAILED DESCRIPTION OF PREFERRED EMBODIMENTS

Embodiments according to the present invention will be described below with reference to the drawings.

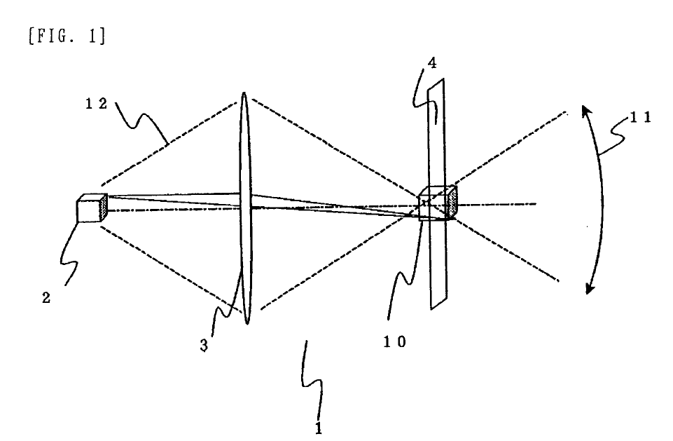

FIG. 1 is a schematic showing a stereoscopic display according to an embodiment. A stereoscopic display 1 according to the embodiment, as shown in FIG. 1, generally includes composite-stereoscopic images 2 electronically formed by a depth sampling system (composite-stereoscopic images), an image-formation lens 3 to reproduce real an images (an image-forming device), and a focusing glass 4 (focusing device).

In the stereoscopic display 1 shown in FIG. 1, numeral 10 denotes real images focused by the image-formation lens 3; numeral 11 denotes a stereoscopically observable range; and dotted lines indicated by numeral 12 represent a range of an effective luminous flux. The luminous flux from the composite-stereoscopic images 2 forms the real images 10 in the vicinity of the focusing glass 4 by the image-formation lens 3. An observer observes the real images 10 stereoscopically. Conjugate images of the electronically formed stereoscopic images are observed, so that the observer can observe the stereoscopic images without wearing any devices, while any number of observers can observe them as long as the observers are within the observable range. The effective-luminous-flux range 12 is determined by the aperture of the image-formation lens 3, and the observable range 11 of the real images 10 agrees with the range of the effective-luminous-flux in the real image side. Therefore, in order to expand the observable range 11, an image-formation lens with a large aperture is required. As the focusing glass 4, an optically translucent sheet or a plate partially having openings may be used. The focusing glass is arranged so that when an observer directly observes the real images, the focal point of the eyes can be easily enabled to coincide with the real image position.

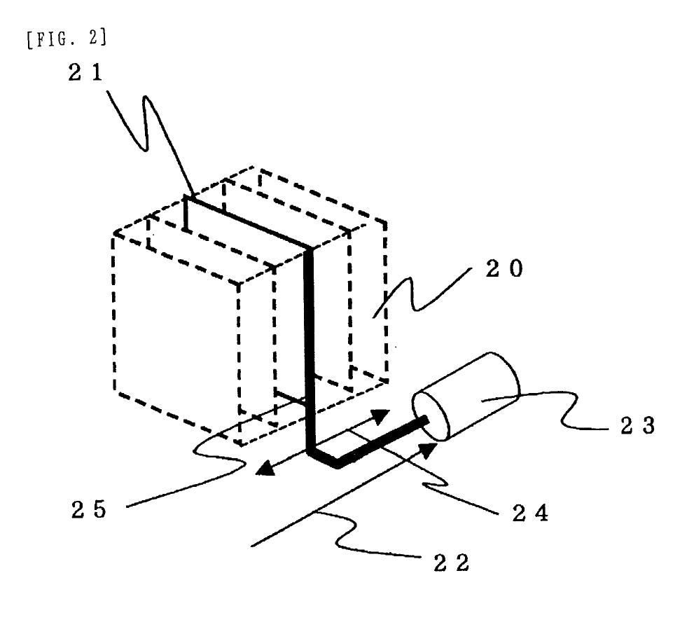

FIG. 2 is a perspective view showing a stereoscopic image-forming device to form composite stereoscopic images. A two-dimensional image-forming device 21 including a matrix-type self-luminous display is mechanically connected to a Z-direction scanning device 23 with a supporting device 25 so as to be scanned 24 in the depth direction (Z-direction 22) perpendicular to X- and Y-scanning directions of the two-dimensional image-forming device 21. As the scanning direction, the Z-direction, which is headed from the two-dimensional image-forming device toward an observer, has an excellent result; however, it is not necessarily perpendicular to the X- and Y-directions because it functions as long as it has depth information. By the way, the Z-direction scanning device 23 includes a high-speed scanning device, such as a voice coil motor. The scanning in the Z-direction at a higher speed than persistence of vision makes a forming space 20 of the electronic composite stereoscopic images.

In such a manner, by the further high-speed scanning of the two-dimensional images produced by the two-dimensional image-forming device in the Z-direction, the composite stereoscopic images can be electronically formed. In the case of a non-selfluminous space-light modulator, such as an LCD, an additional light source device is arranged.

When correcting image magnification or aberration of an image-forming device by controlling the size of a display image of the two-dimensional image-forming device 21 and the scanning amount of the Z-direction scanning device, real images without distortion can be obtained. That is, the two-dimensional images are formed so as to compensate the real image distortion due to the magnification non-linearity or aberration of an image-forming system and the scanning amount and speed in the Z-direction.

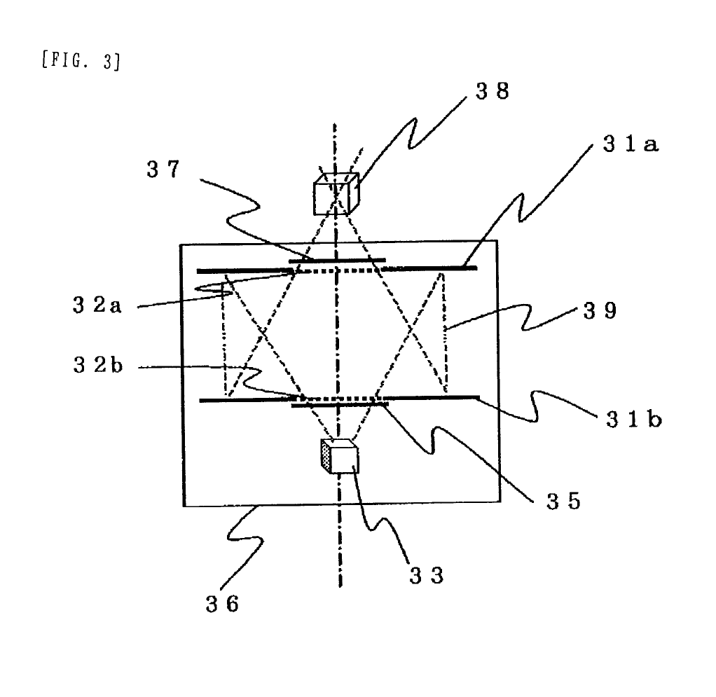

FIG. 3 is a schematic of an embodiment, in which a reflection image-forming optical system is adopted as the image-forming device and a matrix-type light-emitting display is used as the two-dimensional image-forming device.

The reflection image-forming system includes two opposing Fresnel reflection mirrors 31a and 31b having the convex-lens function and openings 32a and 32b formed in the respective centers, where composite stereoscopic images 33 obtained by the matrix-type light-emitting display and the Z-direction scanning is placed below the lower opening so as to form real images 38 at a position in the vicinity of the upper opening. Therefore, the observed real images 38 are finally focused by the lower Fresnel reflection mirror 3 lb, which is a reflection optical element. Dotted lines 39 denote circumferential light-rays and a dash-dot line denotes an optical axis. In particular, according to the embodiment, the following devices are used: large-sized Fresnel reflection mirrors with the same focal length used for a reflection OHP (over head projector) device, an organic LED driven by an active matrix (OLED (organic light emitting diode)) as the matrix-type light-emitting display, and a voice coil motor capable of responding at a high-speed as a Z-direction scanning device.

As the OLED driven by the active matrix, the following devices may be used: a device driven by an Si transistor and exemplified in p. 134 of SID (Society for Information Displays) Digest 2001 and a device driven by a TFT (Thin Film Transistor) and exemplified in p.974 of SID Digest 2001. According to the embodiment, a polymer-type OLED driven by a p-Si TFT is used.

In addition, as shown in FIG. 3, the opening 32b of the lower Fresnel mirror 31b is provided with a lower polarization plate 35 placed to polarize the light functioning to form real images, so that the display light from the OLED is entered in the image-forming system as linearly polarized light. The opening 31b of the upper Fresnel reflection mirror 31 a is provided with an upper polarization plate 37 placed in parallel to the lower polarization plate 35 and in a Nicol state, and by the upper polarization plate 37, the display light is selectively transmitted and the noise light produced in the OLED and the stray light produced in the optical system are absorbed. Moreover, to provide shielding from the outside light, the entire two-dimensional image-forming device is sealed within a dark box 36. The opening 32a of the upper Fresnel reflection mirror 31a and the upper polarization plate 37 have a function of the focusing glass. In addition, in this optical system, the reflection optical element is used as a final optical element to form real images; however, it is not limited to this.

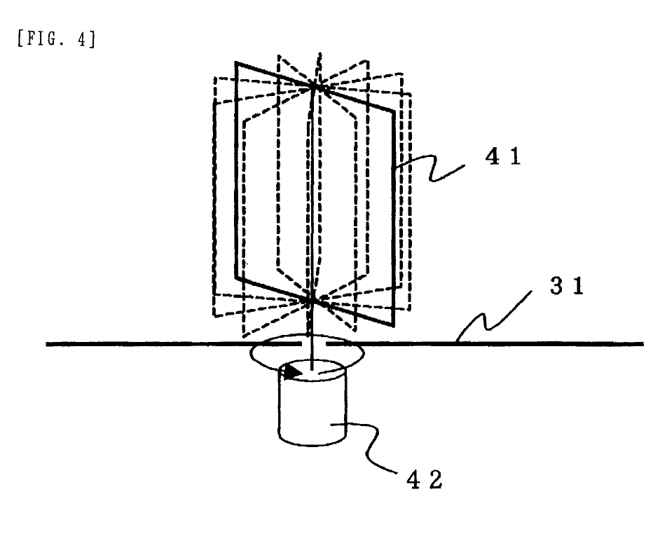

FIG. 4 shows a method to rotate and scan a matrix-type light emitting display 41 as a two-dimensional image-forming device of another electronic composite stereoscopic image-forming method. In the case of FIG. 4, the matrix-type light-emitting display 41 is rotated by a rotationally scanning device 42 at a high speed about a rotational axis disposed in parallel to an image surface. In the same way as the Z-direction scanning, by rotating and scanning at a speed higher than a reaction speed of observer's eyes, composite stereoscopic images can be formed. In order to further reduce or prevent the stray light and to enhance the contrast, a motor, which is a rotationally scanning device 42, and the matrix-type light emitting display are optically separated and shielded from each other by the scanning lower reflection Fresnel mirror 31, which has an opening formed at a part thereof. Therefore, in this composite stereoscopic image-forming method, composite stereoscopic images are placed within the interior of the reflection image-forming system and real images are focused in the vicinity of the opening of the upper Fresnel mirror. When the positions of the composite stereoscopic images and real images satisfy the image-forming relationship in such a manner, an observer can move in the periphery of the Fresnel mirror.

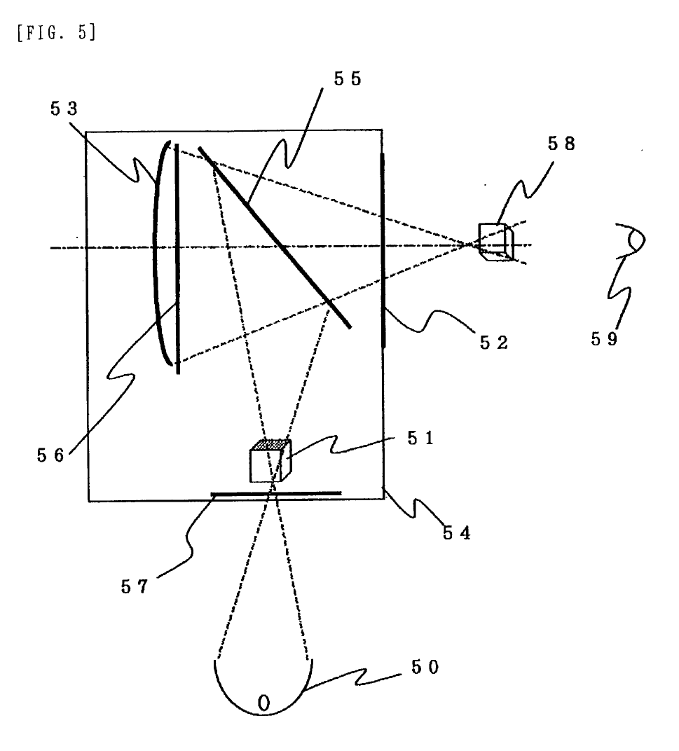

FIG. 5 shows an embodiment in which a reflection image-forming optical system is adopted as the image-forming device and a scattering-type liquid crystal display is used as the two-dimensional image-forming device.

The reflection image-forming system includes a large-aperture concave mirror 53, a polarization splitting mirror 55 to bend an optical path, a quarter-wave plate 56, and polarizing plates 52 and 57, so that real images 58 of electronic composite stereoscopic images 51 are focused in the vicinity of the focal device 52. The composite stereoscopic images 51 formed of the basic configuration shown in FIG. 2 includes a matrix-type scattering liquid crystal display (PDLC-type display), the Z-direction scanning device, and a light source 50. Specifically, it is formed of a PDLC-type display driven by a TFT as the matrix-type scattering display, the Z-direction scanning device driven by a voice coil motor, and the projector-use light source device 50 to project luminous flux toward an effective opening of the concave mirror.

Therefore, the observed real images 58 are finally focused by the large-aperture concave mirror 53, which is a reflection optical element. In addition, the entire optical system other than the two-dimensional image-forming device and the light source device 50 is sealed within a dark box 54, and a polarization plate operating as the focal device 52 is arranged in the vicinity of an image-forming position in the side of an observer 59. Although even a half mirror can operate for the purpose of bending the optical path, according to the embodiment, the polarization splitting mirror 55 has functions to bend the optical path of the polarized light emitted from the electronic composite stereoscopic images by 90 degrees and to detect only the light with a polarization surface rotated by a polarization rotating element comprising the quarter-wave plate and the large-aperture concave mirror so as to select the display light.

From the matrix-type scattering liquid crystal display in a transmitting state, P-polarized light polarized by the polarization plate 57 in the incident side is emitted. However, the P-polarized light passes through the polarization beam splitter 55 so as to be absorbed into the wall of the dark box. However, when the polarized light is irregularly scattered in the matrix-type scattering liquid crystal display, an S-polarized light component is produced, which becomes signal light from the composite stereoscopic images. The signal light, which is the S-polarized light, is reflected by the polarization beam splitter 55, so that the polarizing surface thereof is rotated by 90 degrees by the quarter-wave plate 56 and the large-aperture concave mirror 53 so as to become the P-polarized light and then enter the polarization beam splitter 55 again to pass through it.

The polarizing direction of the polarizing plate 52 arranged outside of the dark box in the vicinity of the opening is aligned with the passing direction of the signal light of the composite stereoscopic images. In such a manner, the real images of composite stereoscopic images are formed. This polarizing plate 52, in addition to the function as the focal device, also has functions of absorbing the stray light produced in the dark box and of preventing the outside light in the periphery of the apparatus from entering the apparatus to be visualized as the noise light.

In addition, the matrix-type scattering liquid crystal display may also be applied to the first and second embodiments described above.

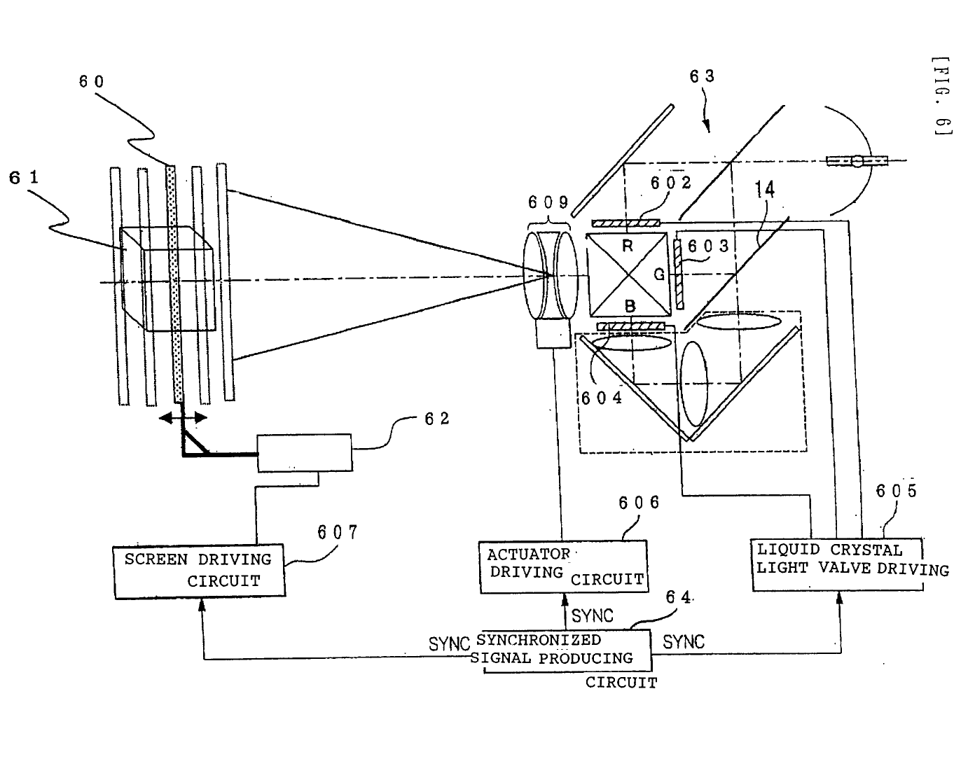

FIG. 6 shows an embodiment using composite stereoscopic images formed by projecting two-dimensional images from a projection device 63 toward a scattering-type screen 60 scanning in the Z-direction at a high speed. As an image-forming device, the reflection-type image-forming optical system shown in FIG. 5 is adopted.

As a method for scanning the scattering-type screen 60 in the Z-direction, the mechanical scanning or a technique of sequentially and electrically scanning deposited scattering-type liquid crystal may be adopted.

FIG. 6 shows the embodiment in which the scattering-type screen 60 is mechanically scanned. Since the projection light enters the scattering-type screen 60 from the opposite side of an observer, it is required to have front screen scattering characteristics capable of substantially covering the effective opening of the image-forming system determining a visualizing range. Then, according to the embodiment, the following devices are used: a scattering white acrylic plate as the screen and a voice coil motor 62 as a technique of scanning the screen in the Z-direction.

Forming the composite stereoscopic images is performed as follows: to the screen 60 placed at a Z-position, two-dimensional images corresponding to the Z-position are projected from the projection display, and by sequentially projecting the two-dimensional images onto the screen 60 scanned at a high speed, the composite stereoscopic images 61 can be electronically formed.

In addition, according to the embodiment, the projection device 63 is provided with a liquid crystal light valve driving circuit 605 to rapidly drive liquid crystal light modulators 602, 603, and 604, which are a two-dimensional image-forming device corresponding to three primary colors R, G, and B so as to sequentially produce two dimensional images sampled in the Z-direction (will be described below). The imageprojection speed of the projection device 63 is switched to be higher by the number of samplings in the Z-direction in comparison with that of two-dimensional image projection. Thereby, the liquid crystal light modulator using ferroelectricity liquid crystal is used.

Then, when displaying the electronic composite stereoscopic images 61 shown in FIG. 6, in the projection device 63, the electronic composite stereoscopic images 61 are divided in the Z-direction into each sampled sectional image produced by each liquid crystal light modulator so as to be sequentially projected toward the screen.

The image forming time per one cage (scanning time of the screen in the Z-direction) to display three-dimensional images is set at 32 milliseconds capable to prevent flickering. When the number of samplings in the Z-direction is 16, the time allocated in one frame to display the two-dimensional images on each liquid crystal light modulator is 2 milliseconds. According to the embodiment, since the space liquid crystal light modulators 602, 603, and 604 in the side of the projection device 63 use liquid crystal light valves using ferroelectricity liquid crystal capable of responding at a high speed, it is sufficient to be displayed within 2 milliseconds.

Where the screen 60 is sequentially scanned at a high speed, so that at an arbitrary time and position, two-dimensional images corresponding to the position have to be projected from the projection device 63. Accordingly, it is required to synchronize scanning the screen 60 with the projection timing of the two-dimensional images from the projection device 63. Furthermore, the movement of a projection lens 609 has to be also synchronized so that the two-dimensional images are focused at the screen position.

Therefore, a stereoscopic image forming apparatus according to the embodiment includes a synchronized signal producing circuit 64 (a synchronizing device), and a synchronized signal SYNC produced in the synchronized signal producing circuit 64 is respectively supplied to the liquid crystal light valve driving circuit 605, a screen driving circuit 607, and an actuator driving circuit 606, so as to synchronize the entire timings of scanning the screen 60, of projecting the two-dimensional images corresponding to the screen position from the projection device 63, and of focusing the projection lens 609 at the screen position.

In the above description, it has been mentioned for brevity that the number of samplings in the depth direction (Z-direction) is agreed with the number of the two-dimensional images to be projected. In practice, the number of Z-samplings is increased than the number of the displayable two-dimensional images. That is, plural two-dimensional image data, each with the slightly changed number of samplings in the Z-direction, are corresponded at one screen position, so that the number of displayable frames in the Z-direction determined by the response speed and Z-scanning time of the liquid crystal light valve can be substantially increased by very slightly shifting the display position in the Z-direction every scanning in the Z-direction. In this configuration, when four two-dimensional data exist for one reference screen position, for example, if the four data are sequentially shifted from the reference screen position by a micro fixed amount in time-series so as to be displayed, more smooth images can be obtained, especially in the case of moving image display. This technique of over sampling can be applied to any case as long as it has depth information, and even the case of rotational scanning shown in FIG. 4 thereby has advantages.

As the space light modulator of the projection device, as well as the liquid crystal light valve using ferroelectricity liquid crystal, a projection device using a DMD (digital mirror device) may also be used. As a magnification optical system, when using a telecentric-type magnification optical system (telescopic optical system), projected images with a comparatively wide range can be obtained without controlling the projection lens.

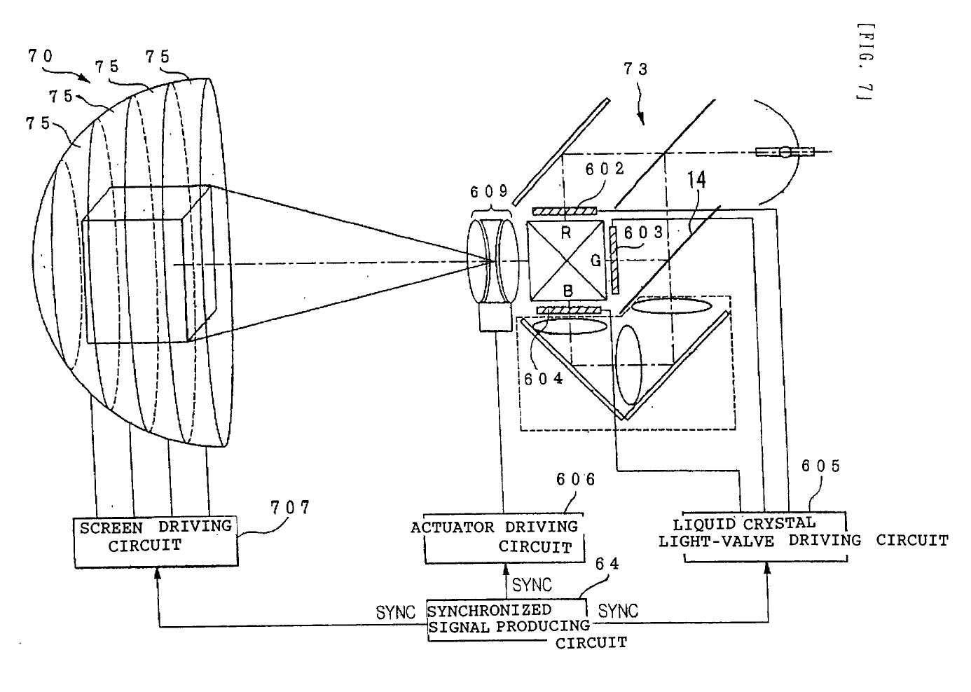

Next, an embodiment of a scattering liquid crystal screen will be described, which is another scattering-type screen and sequentially and electrically scans deposited scattering-type liquid crystal. FIG. 7 is a schematic thereof. A scattering-type liquid crystal screen 70 includes a liquid crystal cell group formed by depositing 16 sets of liquid crystal cells 75 (only four sets being shown in FIG. 7), each cell being able to switch light between a scattering state and transparent state, so as to have a hemispherical shape in its entirety. The spherical side is the image-forming device side and the planar side is the incident surface of the light from the projection device. Each liquid crystal cell includes a pair of transparent substrates, on which transparent conductive films are entirely formed, and an electric field is applied to a liquid crystal layer. Between the liquid crystal cells, there is filled with a material having substantially the same refractive index as that of the transparent substrate, such as PMMA (polymethylmethacrilate).

The screen 70, as shown in FIG. 7, is provided with a screen driving circuit 707 (a screen driving device) which drives the liquid crystal cell group so that any one of the 16 sets of liquid crystal cells 75 is switched into the scattering state and the liquid crystal cell 75 in the scattering state is sequentially scanned at a high speed. Only the images of the liquid crystal cell 75 in the scattering state can be displayed.

A liquid crystal panel in an IRIS (internal-reflection inverted-scattering) mode developed by the present inventors and described in Journal of the SID vol. 7/1, pp. 23-27 is adopted as the liquid crystal cell constituting the screen 70. Because the response speed of this panel is 1 millisecond or less when the voltage applied to the liquid crystal is increased approximately to 20 V, it is sufficient to be responded within 2 milliseconds. This liquid crystal mode uses polymer scattering liquid crystal, which is a type of PDLC (polymer-dispersed liquid crystal), so that by irradiating liquid crystal containing polymer precursor or monomer with UV light, the polymer precursor or monomer is polymerized. At this time, the polymer precursor or monomer is oriented in the liquid crystal as a guest, so that by the photo-polymerization thereof in the oriented state as it is, the polymer skeleton is aligned and fixed in a specific direction. For example, the following devices are used: photosensitive methacrylate as the monomer and nematic liquid crystal made around cyanobiphenyl liquid crystal as the liquid crystal.

By appropriately selecting UV irradiating conditions, a liquid crystal material, a material of the polymer precursor or monomer, the liquid crystal and polymer are oriented in a state that the refractive indexes of the liquid crystal and polymer are substantially agreed therewith, enabling them to become optically transparent. That is, they become transparent in a state that an electric field is not applied to the liquid crystal layer (off state). Then, when the electric field is applied to the liquid crystal layer, the liquid crystal is oriented again along the electric field. The difference in the refractive index is produced from the polymer, which does not follow the electric field, so that incident light does not go straight and is scattered. That is, in the state that the electric field is applied to the liquid crystal layer (on state), the liquid crystal and polymer are in the scattered state. Whereas conventional and general PDLC is scattered in the off state and transparent in the on state, it is a special feature that the IRIS mode liquid crystal panel is transparent in the off state and scattered in the on state.

As the liquid crystal cell constituting the screen, as well as the above-mentioned IRIS mode liquid crystal cell, an NCAP (Nematic Curvilinear Aligned Phase) type and a PN (Polymer Network) type liquid crystal cells may be used when the driving load is not considered.

In such a manner, while the liquid crystal cell 75 in the scattered state is sequentially scanned in the liquid crystal cell group at a high speed, when one arbitrary liquid crystal cell 75 becomes the scattered state at a time, the two-dimensional images corresponding to the scattered liquid crystal cell 75 have to be projected from a projection device 73. Therefore, it is necessary to synchronize the timings of scattering any one of liquid crystal cells 75 on the screen 70 and of projecting the two-dimensional images corresponding to the scattered liquid crystal cell 75 from the projection device 73. Furthermore, the movement of the projection lens is also required to synchronize so that the two-dimensional images are focused on the scattered liquid crystal cell 75. In the same way as the description for FIG. 6 below, the synchronized signal producing circuit 64 (a synchronizing device) is provided, and a synchronized signal STNC produced in the synchronized signal producing circuit 64 is respectively supplied to the liquid crystal light valve driving circuit 605, a screen driving circuit 707, and the actuator driving circuit 606 of the image-forming lens 609 of the projection device. Also, the over sampling in the Z-direction has the same advantages as the case shown in FIG. 6. When four two-dimensional image data exist for one set of liquid crystal cell, for example, if the four data are sequentially displayed in time-series, more smooth images can be obtained.

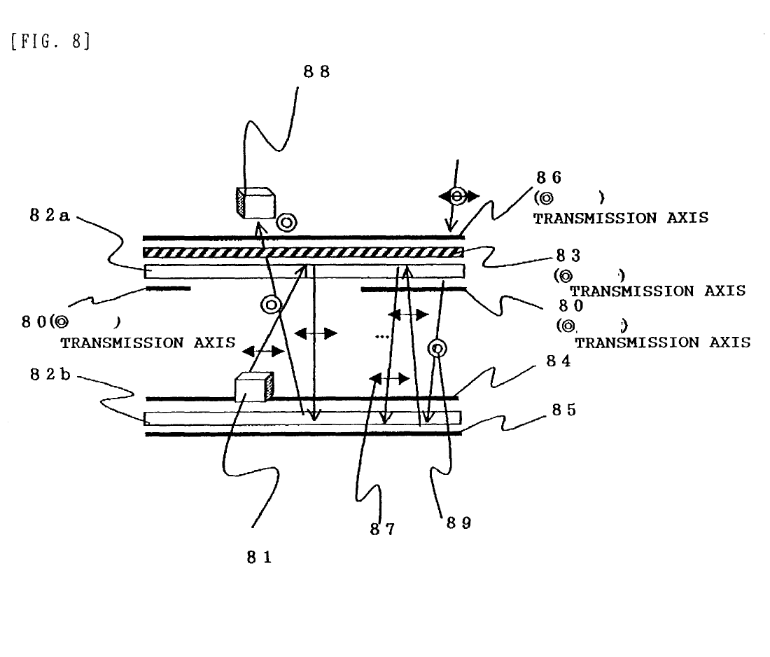

FIG. 8 is a schematic of an embodiment in which the same reflection image forming optical system as that shown in FIG. 3 is adopted as the image-forming device and a polarized-light selection element and a phase plate arranged between the composite stereoscopic images and the focused real images are used.

A stereoscopic display according to the embodiment generally includes electronically formed composite stereoscopic images 81, image-forming optical elements 82a and 82b constituting a reflection image-forming device with a convex-lens function, a reflection-type polarized-light selection element 83 to separate polarized light functioning to form real images 88, a phase-contrast plate 84, and a mirror 85. If necessary, arranging an upper polarized-light element 86 enables the reflection of the outside light from the reflection-type polarized-light selection element 83 to be effectively suppressed. In FIG. 8, both the arrow 87 and double circle 89 represent that the electric-field vibrating direction or transmission axis of the linearly polarized light is parallel and perpendicular to the plane of the figure, respectively.

The image-forming operation as the reflection-type is performed by the two optical elements 82a and 82b with a convex-lens function, the reflection-type polarized-light selection element 83, and the mirror 85. In the polarized light emitted from a point image of the composite stereoscopic images 81 and having passed through the upper image-forming optical element 82a, only the polarized-light electric-field-vibrating in the directions of the double-headed arrow 87 is reflected in the reflection-type polarized-light selection element 83. Then, the polarized-light passes through the lower phase-contrast plate 84 and is reflected back by the mirror 85 via the lower image-forming optical element 82b. The emitted polarized-light, in which the polarization direction is bent by the phase-contrast plate 84 by 90 degrees, enters the reflection-type polarized-light selection element 83 again via the upper image-forming optical element 82a. The image-forming optical elements 82a and 82b are made of a material having substantially small double refraction so as not to affect on phase changes. The transmission axis of the reflection-type polarized-light selection element 83 is arranged to be perpendicular to the plane of the figure indicated by the double circle 89 in FIG. 8, so that only the polarized-light having passed along this optical path from the composite stereoscopic images 81 can be emitted outside. In addition, the transmission axis of the upper polarized-light element 86 is aligned to the transmission direction of the light, so that the light can also pass through this transmission axis. In such a manner, the light having passed along this optical path focuses into the real images 88 so as to be visible by an observer. Also, because the light from the composite stereoscopic images 81 cannot pass through the reflection-type polarized-light selection element, the composite stereoscopic images 81 cannot be directly observed from the upper part. The separation of the direct light due to the polarization remarkably expands visible directions. That is, because being unconstrained by an opening in comparison with related art stereoscopic displays disclosed in U.S. Pat. Nos. 2628533, 3647284, and 5508763, in which the visible direction is limited by forming the opening and the direct light and the displayed light to be focused are separated from each other, the displayed light rays in all the emitting directions are visible. As described above, by the reflection image-forming system capable of achieving separation due to polarization and a large aperture, the visible range is expanded.

On the other hand, although the outside non-polarized light enters the reflecting image-forming device after passing through the upper polarized-light element 86 and the reflection polarized-light selection element 83, it cannot be emitted outside from the image-forming device because the polarization direction is changed after being reflected by the mirror 85 with the lower phase-contrast plate 84 therebetween. It can be emitted after being reflected again; however, the outside light is scarcely emitted outside because of the attenuation due to reflection and the reflection by the optical elements. If necessary, by partially arranging a lower polarization element 80 in the optical image-forming system side (lower side of the numeral 83 in FIG. 8) of the reflection polarized-light selection element 83, the above-mentioned multiple reflection elements can be more effectively absorbed. In such a manner, the noise light due to the outside light can be reduced. As is understood from above, because the outside light and direct light can be eliminated from the real image formation, the real images that are excellent in contrast have been able to be formed. In addition, in FIG. 8, the polarization state of the outside light is illustrated by neglecting the lens function for brevity.

The composite-stereoscopic images 81 are formed by the devices above described in the first to third embodiments. For example, a device, in which an X-Y matrixtype display is scanned in the Z-direction, may be applied; however, it is required that the polarized-light responsible for image-formation in the light from the composite-stereoscopic images 81 be directly emitted or be polarized by a polarization element. For example, when the outside light enters the reflection image-forming system via the polarization plate, as shown in FIG. 3, or arranging the polarization plate covering the luminous flux heading for the reflection polarized-light selection element in the vicinity of the composite-stereoscopic images even if the composite-stereoscopic images are arranged inside, the emitting of the polarized-light may be substantially performed. For such a reason, the position of the composite-stereoscopic images 81 is not clearly indicated in FIG. 8 because it may be enough to form the real images.

More specifically, according to the embodiment, as the reflection polarizedlight selection element, the following devices may be used: a D-BEF type polarizer (made by 3M) described in International Display Research Conference 1997 p. M-98, a combination of Brightmax (made by Merck) described in “EKISHO” vol. 2, 1988, p. 32 with a quarter-wave plate, and a Wire-Grid type polarizer described in SID Digest 2001 p.1282, p. 1287. As the image-forming element of the reflection image-forming device, a Fresnel lens having a convex lens function with small double-refraction and small distortion, etc., may be preferably used. For the phase plate, a broadband quarter-wave plate is preferable.

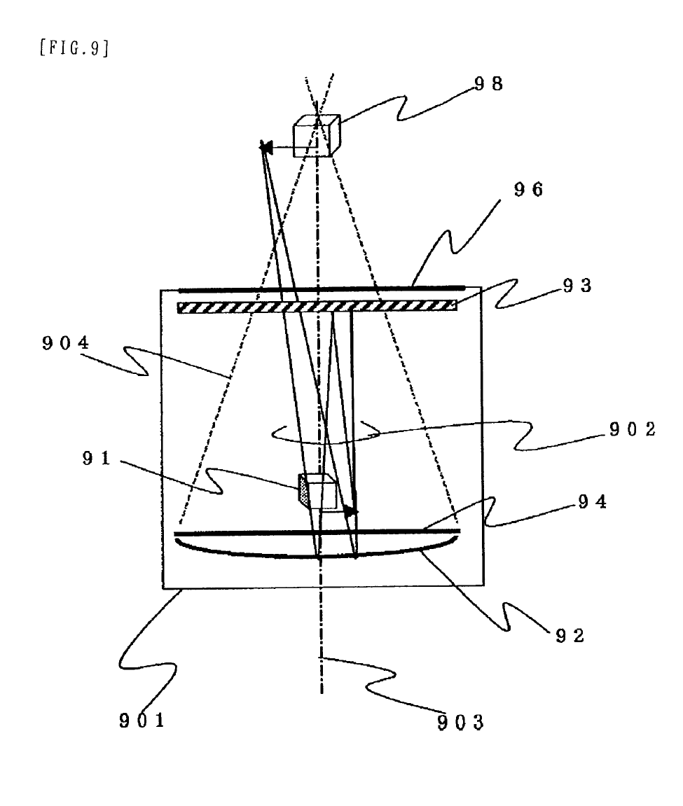

FIG. 9 is a schematic of a stereoscopic display 901 using one concave mirror 92 as a reflection image-forming optical system and a D-BEF element as a reflection polarized-light selection element 93. The polarized display light (parallel to the plane of the figure) from composite-stereoscopic images 91 is reflected by the D-BEF element 93 (the constituent part perpendicular to the plane of the figure is transmitted); then, the polarized-light is bent by 90 degrees by a quarter-wave plate 94 and is reflected by the concave mirror 92 so as to enter the D-BEF element 93 again. Because the display light is in the polarized state capable of transmitting the D-BEF element 93, it passes through the D-BEF element 93 and a polarization plate 96 (the transmission axis is perpendicular to the plane of the figure) so as to form real images

2 denote rays parallel to an optical axis 903 and rays passing a principal point showing the image-forming relationship in a paraxial region.

Numbers 904 denotes the maximum visible range determined by the reflection image-forming optical system. The composite-stereoscopic images 91 are formed by the X-Y matrix-type display with the Z-direction scanning applied thereto and above-described in the first to third embodiments and the display light is emitted therefrom via the polarization plate.

When observing the formed stereoscopic real images 98, because almost all of the outside light other than the stereoscopic real images is absorbed, the real images are observed floating against the black background. This is because, when viewing the polarization plate 96 from an upper part, the outside light is absorbed since the condition is approximately equivalent to the configuration in which the quarter-wave plate and the mirror are arranged under the polarization plate. The entire stereoscopic display 901 is accommodated within an optical dark box, into which the outside light cannot penetrate. According to the embodiment shown in FIG. 9, there is an advantage of eliminating the expensive Fresnel lens with small double-refraction and small distortion, etc., by using only the concave mirror as the reflection image-forming element.

is a schematic of a case, in which a concave mirror 102 and a Fresnel lens 1000 having a convex-lens function as the reflection image-forming optical system and the above-mentioned Wire-Grid element 103 as the reflection polarized-light selection element are used. The Wire-Grid element 103, formed of a metallic fine-wire array of order of sub-micron, has a polarized-light selecting function to reflect a linearly polarized-light in the fine-wire direction while transmitting the polarized-light perpendicular thereto. That is, the Wire-Grid element 103 corresponds to the linearly polarized-light perpendicular to the light incident substantially vertically and has a function to select the reflection and transmission.

The circularly-polarized incident display-light due to a circular polarization element 1006 becomes linearly polarized-light (parallel to the plane of the figure) by a quarter-wave plate 104 so as to enter the reflection image-forming system via an opening 1005 of the concave mirror. The display light that becomes the linearly polarized-light transmits the Fresnel lens 1000 and is reflected by the above-mentioned Wire-Grid element 103 (component perpendicular to the plane of the figure is transmitted). Next, it enters the quarter-wave plate 104 and the concave mirror 102, and the polarized-light thereof is thereby bent by 90 degrees and reflected so as to enter the Fresnel lens 1000 and the Wire-Grid element 103 again. Because the display light is in the polarized state capable of transmitting the Wire-Grid element 103 at this time, it transmits the Wire-Grid element 103 and a polarization plate 106 (the transmission axis is perpendicular to the plane of the figure) so as to form real images 108.

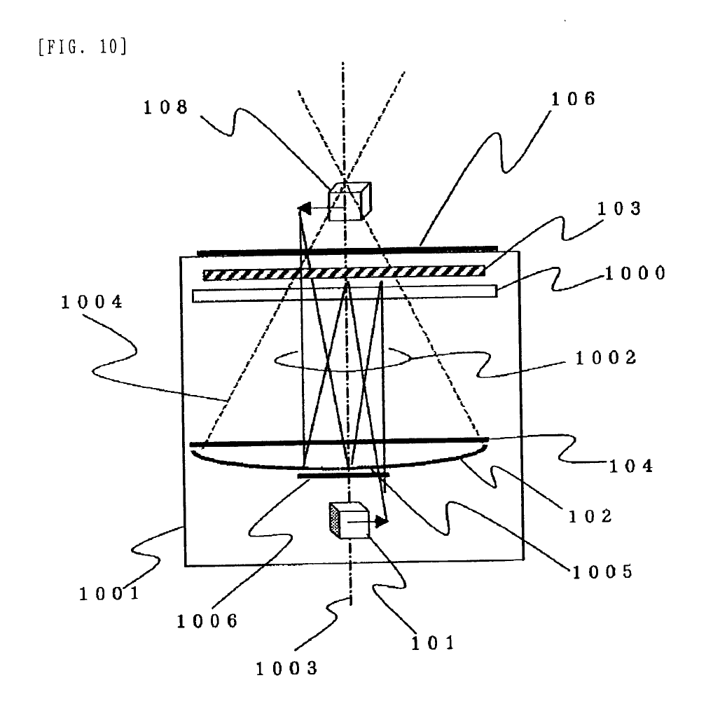

specifically, a large-sized lens having a focal length of 1000 mm with small double-refraction and small distortion for use in an over-head projector is used as the Fresnel lens. A reflection lens configured by combining it with the Wire-Grid element 103 yields approximately half of the focal length. The focal length of the other concave mirror is set at 500 mm the same as the Fresnel lens, and the distance between the concave mirror and the Fresnel lens is set approximately at 400 mm. Composite-stereoscopic images 101 and observed real images 108 are configured outside of the concave mirror 102 and the Fresnel lens 1000. In such a manner, a reflection image-forming optical system with 1 magnification is configured. In FIG. 10, light rays group 1002 show the image-forming relationship in a paraxial region relative to an optical axis 1003. Numeral 1004 denotes the maximum visible range determined by the reflection image-forming optical system. An entire stereoscopic display 1001 is accommodated within an optical dark box, into which the outside light cannot penetrate.

1 of the stereoscopic display are formed of the devices above-described in the first to third embodiments the polarization element and reflection polarized-light selection element in the observer side are observed by an observer from the upper part, so that the focus is adjusted on the vicinity thereof. Because real images are formed in the vicinity thereof, there is an advantage of easily adjusting the focus of eyes on the real images.

The stereoscopic displays according to the present invention shown in FIGS. 9 and 10 can achieve a clear stereoscopic display by separating display light from noise light by polarization. Also, because free of limitation due to an opening, the field of view is large so that real images as they are composite-stereoscopic images can be observed by a number of people.

As described above in detail, according to the present invention, stereoscopic real images with high contrast and without distortion and also being capable of very finely moving can be reproduced on a space.

Also, because a light-emitting type color matrix display, scattering-type liquid crystal matrix display, and color projector can be adopted as original images of the two-dimensional images, full-color moving real images can be readily reproduced.

Moreover, the field of view is large so that a number of people can observe simultaneously, enabling various applications, such as medical use, industrial use, and further game use to be incorporated.

Because the real images of electronic composite stereoscopic images are observed, a pointer of an inner force sense device is penetrable into a real image reproducing space. For example, the feel of a CT image can be obtained by touching the pointer at the inside thereof. In such a manner, the stereoscopic display entails the inner force sense device.

By rotationally scanning in the depth direction and by projection-type two-dimensional image forming, mechanical vibration can be eliminated, enabling calm display to be performed.

According to the present invention, since human both eyes parallax is not utilized, a body-worn device, such as polarized glasses, is not required. Because the contradiction between the vergence and adjustment is not felt, a stereoscopic display capable of displaying natural three-dimensional stereoscopic images without tiredness can be achieved.

Furthermore, by separating display light from noise light and outside light by polarized light, real images with high contrast can be observed. Because the direct light from the stereoscopic images can be also limited, the formed real images cannot be observed to overlap with the composite stereoscopic images. In comparison with a technique of separating display light by an opening, there is also an advantage that a visible area is not limited by the opening.

A large-aperture image-forming system is configured by using a reflection image-forming optical system, thereby further increasing the visible range. Because the optical path is foldable, the apparatus can be compactly formed.

What is claimed is:

1. A stereoscopic display, comprising:
a device to electronically form composite stereoscopic images;
an image forming device to reproduce real images of the composite stereoscopic images; and
a focal device to substantially align the real images with a focal point position of eyes of an observer.

2. The stereoscopic display according to claim 1, the image forming device including a final optical component to form the real images, the final optical component being a reflection optical element.

3. The stereoscopic display according to claim 1, the image forming device being an optical system that includes a polarization element to polarize light functioning to form the real images and a polarization element to select display light.

4. The stereoscopic display according to claim 1, the image forming device including a final optical component, the final optical component including a large aperture concave mirror; the stereoscopic display including:
a polarization element including a polarization splitting mirror to select the display light; and
a polarization rotating element to rotate the polarized light when reflecting at the large aperture concave mirror.

5. A stereoscopic display for observing real images, comprising:
a device to electronically form composite stereoscopic images;
an image forming device to reproduce the real images of the composite stereoscopic images; and
a two-dimensional forming device, the composite stereoscopic images being formed by scanning two-dimensional images produced by the two-dimensional image forming device at a high speed in a depth direction.

6. The stereoscopic display according to claim 5, the two-dimensional image forming device displaying two-dimensional images in which an image magnification and an aberration of the image forming device are corrected corresponding to the two-dimensional images and a scanning position in the depth direction.

7. A stereoscopic display for observing real images, comprising:
a device to electronically form composite stereoscopic images;
an image forming device to reproduce the real images of the composite stereoscopic images; and
a two-dimensional image forming device, the composite stereoscopic images being formed by rotationally scanning two-dimensional images produced by the two-dimensional image forming device about a rotational axis parallel to an image surface.

8. The stereoscopic display according to claim 1, the two-dimensional image forming device to form the composite stereoscopic images being a matrix-type light emitting display.

9. The stereoscopic display according to claim 1, the two-dimensional image forming device to form the composite stereoscopic images being a scattering-type liquid crystal display.

10. The stereoscopic display for observing real images, comprising:
a device to electronically form composite stereoscopic images;
an image forming device to reproduce the real images of the composite stereoscopic images;
a scattering-type screen; and
a two-dimensional image forming device, the composite stereoscopic images being formed by synchronously projecting two-dimensional images produced by the two-dimensional image forming device on the scattering-type screen scanned at a high speed.

11. The stereoscopic display according to claim 10, in the scattering-type screen, deposited scattering-type liquid crystal being switchable between a scattered state and a transparent state of light being sequentially and electrically scanned.

12. The projection-type stereoscopic display according to claim 10, the composite stereoscopic images formed by synchronous projection on the scattering-type screen being synchronously projected by a projection device that includes a controller to control a relative distance between a projection lens and the scattering-type screen.

13. The stereoscopic display according to claim 10, the composite stereoscopic images formed by synchronous projection on the scattering-type screen being synchronously projected by using a telecentric-type magnification optical system.

14. The stereoscopic display according to claim 1, a number of depth-information samplings of the composite stereoscopic images being set to be larger than a number of samplings of two-dimensional images capable of being displayed.

15. The stereoscopic display for observing real images, comprising:
a device to electronically form composite stereoscopic images; and
a reflection image forming device to reproduce the real images of the composite stereoscopic images, the reflection image forming device being an optical system that includes a reflection polarized-light selection element to reflect and separate the polarized light functioning to form the real images between the composite stereoscopic images and the formed real images and a phase plate to rotate the polarized light functioning to form the real images.

16. The stereoscopic display according to claim 15, the reflection polarized-light selection element corresponding to linearly polarized light perpendicular to the incident light in a substantially vertical direction and having a function to select between reflection and transmission.

17. The stereoscopic display according to claim 15, the reflection image forming device including an optical system that includes the reflection polarized-light selection element to separate display light and noise light from the polarized light functioning to form the real images and a polarization element to transmit the display light.
